(19) United States
(12) Patent Application Publication
(10) Pub. No.: US 2004/0234370 A1
(43) Pub. Date: Nov. 25, 2004

(54) Chopping pump impeller assembly

(76) Inventors: Mark Simakaski, Chester, NJ (US); Edward Belcak, Philadelphia, PA (US)

Correspondence Address: Roetzel & Andress, 222 S. Main St., Akron, OH, 44308, US

(21) Appl. No.: 10/672,460

(22) Filed: Sep. 26, 2003

Related U.S. Application Data
(60) Provisional application No. 60/414,214, filed on Sep. 26, 2002.

(51) Int. Cl. F03B 3/12

(52) U.S. Cl. 415/121.1

(57) ABSTRACT

An impeller assembly, chopping pump, method of operation, and method of converting an existing pump into the chopping pump. The chopping pump includes a pump housing for enclosing a pumping chamber, the pump housing having an inlet flange through which a fluid is to be introduced into the pumping chamber at a first pressure, and an outlet flange through which the fluid is to be discharged from the pumping chamber at a second pressure, the pump further including a rotatable shaft that is to be operatively coupled to a pump driving device. The impeller assembly includes a cutter bar to be coupled to the pump housing adjacent to the inlet flange, and an impeller for imparting a centrifugal force on fluid entering the pumping chamber, the impeller being mountable on the shaft at a distance from the cutter bar when the cutter bar is coupled to the pump housing to form a clearance between the impeller and the cutter bar.

### RELATED APPLICATIONS

This application claims the benefit of U.S. Provisional Application No. 60/414,214, filed Sep. 26, 2002.

### FIELD OF THE INVENTION

The present invention relates generally to pumps, and more specifically to chopping pump impeller assemblies, chopping pumps, methods for converting an existing pump into a chopping pump, and methods for operating a chopping pump.

### BACKGROUND OF THE INVENTION

Recessed impeller pumps have been used in many applications that require low maintenance and high reliability, such as storm sewer drainage. Conventional recessed impeller pumps such as those manufactured by TwinPumps, Inc. of Oldwick, N.J., for example, include a pump housing defining a pumping chamber, a drive shaft that is rotatably supported to extend through the pump housing, the drive shaft being rotatable by an external motor, and a recessed impeller. The recessed impeller is separated from an inlet flange of the pump housing by a distance such that rotation of the impeller creates a vortex between the inlet flange and the impeller. Centrifugal forces exerted on the fluid within the pump due to the vortex forces the fluid to be discharged through an outlet flange in the pump housing.

The flow path for a fluid through the conventional recessed impeller pump runs from the inlet flange to the outlet flange. The impeller is recessed, and is thus positioned outside of this flow path. The vortex created by rotation of the impeller sucks material in through the inlet flange from an attached plumbing network and discharges the fluid through the outlet flange. Fluid can enter through the inlet flange and leave through the outlet flange without contacting the impeller. Typically, only about 10%-15% of the fluid comes in contact with the impeller.

Because the impeller is outside of the fluid flow path, objects as large as the size of the inlet flange can pass through the pump without clogging the pump. Cleaning and maintenance costs are minimal for the recessed impeller pump. The recessed impeller pump has a disadvantage, in that it is inefficient relative to some other conventional pump configurations. Efficiencies below 50% are typical for recessed impeller pumps.

An alternative to the recessed impeller pump is a chopping pump. Chopping pumps include an impeller with a chopping blade and a cutter bar that is secured to the pump housing at an inlet flange. During pump rotation, the chopping blade passes close to the cutter bar and shears any solid material that enters the inlet flange. The chopped material can then pass through the pump. Chopper pumps can achieve significantly greater efficiency than recessed impeller pumps; efficiencies between 60% and 70% are common. Because solid material is chopped by the chopping impeller, chopper pumps also experience minimal clogging due to ingestion of objects entrained in the fluid. Chopper pumps also have relatively low maintenance costs. However, many process applications currently employ recessed impeller pumps, and, due to cost concerns, replacing the recessed impeller pumps is not a viable option. Further, conventional chopping pumps are built specifically for a designated environment. Such chopping pumps can not be used effectively in alternate environments where objects entrained in the fluid to be pumped are different in size than the objects entrained in the fluid of the designated environment.

In situations where a large number of objects are entrained in the fluid being pumped by a chopping pump, or where a chopping pump ill-suited for the present application is employed, a number of objects entrained in the fluid can enter the pumping chamber without being sheared or otherwise chopped. These objects, once inside the pumping chamber, clog the pump and hamper the pumping ability of the pump. And with conventional chopping pumps, it is difficult to discern when the shearing and chopping of the objects entering the pumping chamber is being performed as desired.

Accordingly, there is a need in the art for a chopping pump and chopping pump conversion assembly that can minimize the accumulation of objects in the pumping chamber that can interfere with the pumping ability of the chopping pump, and that can be adapted for use in a plurality of environments. The chopping pump should be available as a unit for applications currently without a pump and as a replacement of an existing pump. The chopping pump conversion assembly should confer one or more of the advantages of the chopping pump without requiring the replacement of the entire existing pump.

### SUMMARY OF THE INVENTION

In accordance with one aspect, the present invention provides an impeller assembly to be installed in a pump. The pump comprises a pump housing for enclosing a pumping chamber, an inlet flange through which a fluid is to be introduced into the pumping chamber at a first pressure, an outlet flange through which the fluid is to be discharged from the pumping chamber at a second pressure, and a rotatable shaft that is to be operatively coupled to a pump driving device. The impeller assembly comprises a cutter bar to be coupled to the pump housing adjacent to the inlet flange, and an impeller for imparting a centrifugal force on fluid entering the pumping chamber. The impeller is mountable on the shaft at a distance from the cutter bar when the cutter bar is coupled to the pump housing to form a clearance between the impeller and the cutter bar. The impeller comprises a concavity shaped to direct at least a portion of the fluid entering the pumping chamber generally toward the clearance between the impeller and the cutter bar.

In accordance with another aspect, the present invention provides an impeller assembly to be installed in a pump. The pump comprises a pump housing for enclosing a pumping chamber, an inlet flange through which a fluid is to be introduced into the pumping chamber at a first pressure, an outlet flange through which the fluid is to be discharged from the pumping chamber at a second pressure, and a rotatable shaft that is to be operatively coupled to a pump driving device. The impeller assembly comprises a cutter bar to be coupled to the pump housing adjacent to the inlet flange, and an impeller for imparting a centrifugal force on fluid entering the pumping chamber. The impeller is mountable on the shaft at a distance from the cutter bar when the cutter bar is coupled to the pump housing to form a clearance between the impeller and the cutter bar, wherein a position of the cutter bar is adjustable relative to the impeller to provide adjustment of the clearance between the cutter bar and the impeller.

In accordance with another aspect, the present invention provides a pump comprising a pump housing for enclosing a pumping chamber, the pump housing having an inlet flange through which a fluid is to be introduced into the pumping chamber at a first pressure, and an outlet flange through which the fluid is to be discharged from the pumping chamber at a second pressure. A rotatable shaft is provided to be operatively coupled to a pump driving device. The pump further comprises a cutter bar and an impeller for imparting a centrifugal force on fluid being introduced into the pumping chamber, the impeller being mountable on the shaft at a distance from the cutter bar within the pump housing to form a clearance between the impeller and the cutter bar. The impeller comprises a concavity shaped to direct at least a portion of the fluid entering the pumping chamber generally toward the clearance between the impeller and the cutter bar as the impeller is rotated.

In accordance with another aspect, the present invention provides a pump comprising a pump housing for enclosing a pumping chamber, the pump housing having an inlet flange through which a fluid is to be introduced into the pumping chamber at a first pressure, and an outlet flange through which the fluid is to be discharged from the pumping chamber at a second pressure; a rotatable shaft that is to be operatively coupled to a pump driving device; a cutter bar; and an impeller. The impeller is for imparting a centrifugal force on fluid being introduced into the pumping chamber, the impeller being mountable on the shaft at a distance from the cutter bar within the pump housing to form a clearance between the impeller and the cutter bar. A position of the cutter bar is adjustable relative to the impeller within the pump housing to provide adjustment of the clearance between the cutter bar and the impeller.

In accordance with another aspect, the present invention provides a pump comprising a pump housing for enclosing a pumping chamber, the pump housing having an inlet flange through which a fluid is to be introduced into the pumping chamber at a first pressure, and an outlet flange through which the fluid is to be discharged from the pumping chamber at a second pressure; a rotatable shaft that is to be operatively coupled to a pump driving device; a cutter bar; and an impeller. The impeller is for imparting a centrifugal force on fluid being introduced into the pumping chamber, the impeller being mountable on the shaft at a distance from the cutter bar within the pump housing to form a clearance between the impeller and the cutter bar. The pump further comprises an inspection port for observing the clearance between the impeller and the cutter bar.

In accordance with another aspect, the present invention provides a method for converting a recessed impeller pump into a chopping pump, the recessed impeller pump having an existing impeller recessed within a pumping chamber. The method comprises removing an existing impeller and an existing inlet flange from the recessed impeller pump, mounting a cutter bar to an inlet flange, and mounting an impeller on a rotatable shaft of the recessed impeller pump. The impeller has a concavity shaped to direct at least a portion of fluid entering the pumping chamber generally toward the cutter bar.

In accordance with another aspect, the present invention provides a method for operating a pump, the pump comprising a pump housing enclosing a pumping chamber, an inlet flange through which a fluid can enter the pumping chamber, an outlet flange through which the fluid is discharged from the pumping chamber, and a cutter bar coupled adjacent to the inlet flange. The method comprises receiving a fluid through the inlet flange, rotating an impeller adjacent to the cutter bar to chop objects entrained in the fluid, and directing at least a portion of the fluid entering the pumping chamber generally toward a clearance between the impeller and the cutter bar.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a partial cut away perspective view of a chopping pump in accordance with an embodiment of the present invention;

FIG. 2 is a cross-sectional view of a pump according to an embodiment of the present invention;

FIG. 3 is an elevational view of a plate and cutter bar assembly according to an embodiment of the present invention;

FIG. 4 is a cross-sectional view of the plate and cutter bar assembly shown in FIG. 3, taken along section line 4-4 of FIG. 3;

FIG. 5 is an elevational view of an example of an inlet flange arrangement according to an embodiment of the present invention;

FIG. 6 is a cross-sectional view of the inlet flange shown in FIG. 5, taken along section line 6-6 of FIG. 5;

FIG. 7 is a perspective view of an example of an impeller according to an embodiment of the present invention;

FIG. 8 is an elevational view of the impeller shown in FIG. 7;

FIG. 9 is a cross-sectional view of the impeller shown in FIGS. 7 and 8, taken along section line 9-9 of FIG. 8;

FIG. 10 is a partial cross-sectional view of an impeller according to an embodiment of the present invention, a concavity of the impeller directing at least a portion of fluid in a pumping chamber generally toward a clearance between the impeller and a cutter bar;

FIG. 11 is a flow chart of a method for converting an existing pump into a chopping pump in accordance with an embodiment of the present invention; and

FIG. 12 is a flow chart of a method of operating a chopping pump.

### DETAILED DESCRIPTION OF AN ILLUSTRATIVE EMBODIMENT

Certain terminology is used herein for convenience only and is not to be taken as a limitation on the present invention. Further, in the drawings, certain features may be shown in somewhat schematic form.

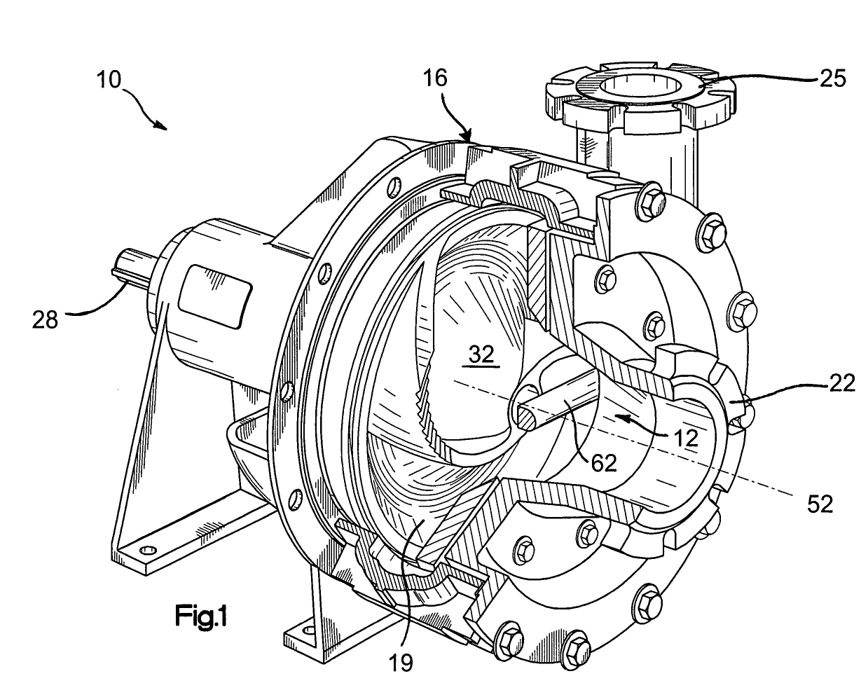

FIG. 1 is a partial cutaway view of a pump 10 according to an embodiment of the present invention. The pump 10 can be fabricated as a new pump, fabricated by retrofitting an impeller assembly 12 according to the present invention into a recessed impeller pump, and can be formed in any other manner without departing from the scope of the present invention. As shown in FIG. 1, the pump 10 comprises a pump housing 16 that encloses a pumping chamber 19, an inlet flange 22 and an outlet flange 25 provided to the pump housing 16, and a drive shaft 28 that extends from the pump housing to be operatively coupled to a pump driving device such as a motor, turbine, and any other prime mover (not shown). Fluid is introduced into the pumping chamber 19 at a first pressure through the inlet flange 22. Objects such as solid debris entrained in the fluid being introduced into the pumping chamber 19 are chopped rotation of an impeller 32 adjacent to a cutter bar 62 provided adjacent to the inlet flange 22. Within the pumping chamber 19, the rotating impeller 32 imparts a centrifugal force on the fluid, thereby creating a spiraling flow pattern in the form of a vortex. At least a portion of the fluid in the pumping chamber 19 is directed generally toward the impeller 32 and the cutter bar 62 to minimize the size of objects within the pumping chamber 19. The vortex flow pattern causes the remaining portion of the fluid in the pumping chamber 19 to be discharged at a second pressure from the pump 10 through the outlet flange 25.

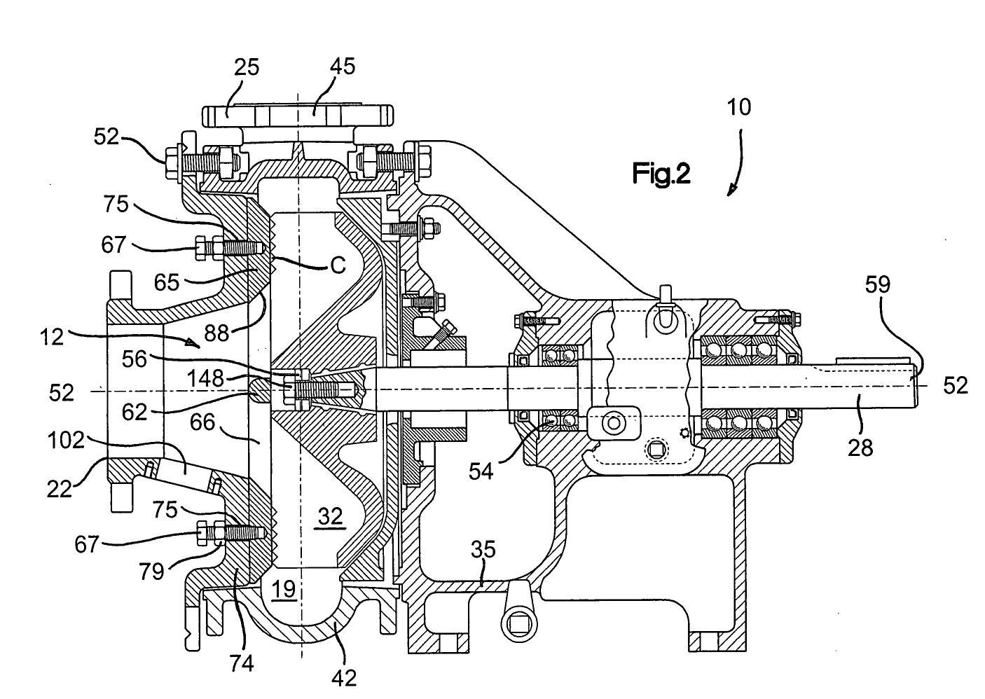

FIG. 2 is a cross-sectional view of the pump 10 equipped with the impeller assembly 12 in accordance with the present invention. Pump housing 16 includes the inlet flange 22 coupled to a base portion 35, the inlet flange 22 and the base portion 35 being separated by an annular spacer 42. Outlet flange 25 defines a generally tubular interior passage 45 in the spacer 42 through which the fluid is to be discharged from the pumping chamber 19. A plurality of threaded fasteners 48 cooperate with the inlet flange 22, base portion 37, and the spacer 42 to couple those objects together. Fastening devices such as clamps, rivets, and other releasable fasteners can be used with, or in lieu of, the threaded fasteners 48 to couple the portions of the pump housing 16 together without departing from the scope of the present invention. Gaskets (not shown) are disposed at the interfaces of the inlet flange 22, base portion 37, and the spacer 42 to minimize the amount of fluid that can leak therebetween.

The drive shaft 28 is rotatably supported to extend along central axis 52 within the base portion 35 of the pump housing 16 by rotatable support means such as ball bearings 54 and the like. A proximate end 56 of the drive shaft 28 extends into the pumping chamber 19 and is adapted to support the impeller 32. A distal end 59 of the drive shaft extends from within the base portion 35 of the pump housing 16 and away from the pumping chamber 19. Operatively coupling the distal end 59 of the drive shaft 28 to the pump driving device, either directly or through a gear box, for example, transmits a rotational force supplied by the pump driving device to the impeller 32, thereby causing rotation of the impeller 32.

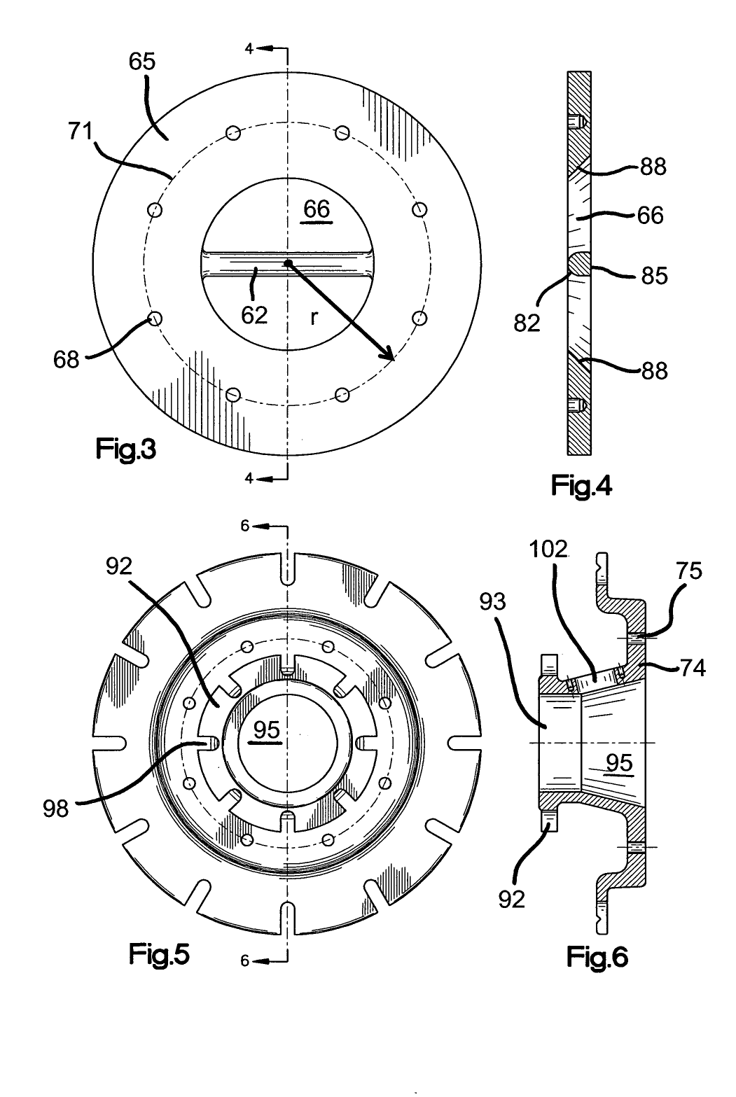

The impeller assembly 12 comprises the impeller 32 and a cutter bar 62 provided adjacent to the inlet flange 22. Best shown in FIG. 3, the cutter bar 62 is a generally rectangular member that extends along a diameter of a generally circular interior passage 66 defined by an annular plate 65. The plate 65 is to be adjustably coupled to the inlet flange 22 with a plurality of threaded fasteners 67 (FIG. 2) to support the cutter bar 62 in the path of fluid flowing through the inlet flange 22. Receptors 68 that are compatibly threaded for communication with the threaded fasteners 67 are formed along an isometric path 71 about the plate 65 a radial distance r from a midpoint 72 of the cutter bar 62.

When installed on the pump 10, the plate 65 is placed adjacent to a cutter bar mounting portion 74 of the inlet flange 22 such that the receptors 68 are aligned and in registry with apertures 75 (FIGS. 2 and 6) formed in the inlet flange 22. Each aperture 75 in the inlet flange 22 can also be provided with a threaded nut 79, for example, that is coaxial with the aperture 75. Arranged in this manner, each threaded fastener 67 extends through a nut 79 and an aperture 75, and into a receptor 68 to adjustably couple the plate 65 and cutter bar 62 adjacent to the inlet flange 22.

The cutter bar 62 can be adjusted in an axial direction generally parallel to axis 52 and relative to the position of the impeller 32. Selectively advancing and/or retracting one or more of the threaded fasteners 67 relative to the inlet flange 22 adjusts the position of the cutter bar 62. Rotating the one or more threaded fasteners 67 in a first rotational direction causes communication between the threaded portions of the fasteners 67 and the apertures 75 and/or the nuts 79. The communication between the threaded portions advances fasteners 67 in a generally axial direction toward the impeller 32. Advancing the fasteners 67 in this direction separates the plate 65, and accordingly, the cutter bar 62, a first distance from the cutter bar mounting portion 74 of the inlet flange 22. By adjusting the position of the cutter bar 62 in this manner, a clearance C between the cutter bar 62 and the impeller 32 is established.

Conversely, rotating the one or more threaded fasteners 67 in a second rotational direction causes communication between the threaded portions of the fasteners 67 and the apertures 75 and/or the nuts 79. This communication between the threaded portions retracts fasteners 67 in a generally axial direction away from the impeller 32. Retracting the fasteners 67 in this direction separates the plate 65, and accordingly, the cutter bar 62, a second distance from the cutter bar mounting portion 74 of the inlet flange 22. Adjusting the position of the cutter bar 62 in this manner, the clearance C between the cutter bar 62 and the impeller 32 is increased from the clearance C established above when the fasteners 67 were rotated in the first rotational direction.

The rotation of the fasteners 67 in the first and second rotational directions is preferably accomplished externally of the pump housing 16 to permit adjustment of the clearance C between the cutter blade 62 and the impeller 32 without requiring significant disassembly of the pump housing 16. However, a cap (not shown) and any other object provided to conceal the fasteners 67 for protective purposes, for example, can be removed to access the fasteners 67 without amounting to a disassembly of the pump housing 16.

FIG. 4 provides an example of a cutter bar 62 and plate 65 that can be provided in the pump 10 of the present invention to minimize the accumulation of objects, such as debris and other solids entrained in the fluid, at the inlet flange 22. The cutter bar 62 includes an arcuate surface 82 to be oriented upstream of a generally linear surface 85. Objects impacting the arcuate surface 82 are typically directed around the cutter bar 62 in the direction of the bulk fluid flow into the pumping chamber 19. Similarly, the plate 65 is provided with an angled portion 88 around the interior passage 66 that opens in the direction of fluid flowing into the pumping chamber 19. The angled portion 88 minimizes interference with fluid flowing into the pumping chamber 19 to minimize so-called “bottlenecking” at the entrance to the pumping chamber 19.

Although the cutter bar 62 was described above and illustrated in FIG. 3 as a generally rectangular member extending across an interior passage 66 defined by a plate 65, it is understood that other arrangements are also included in the present invention. For example, the cutter bar 62 can comprise a generally linear member that does not extend across an interior passage defined by a plate. For such an arrangement, an aperture (not shown) formed in opposite ends of the cutter bar is to be aligned with corresponding apertures formed in the cutter bar mounting portion 74 of the inlet flange 22 to adjustably couple the cutter bar 62 to the inlet flange 22. Adjustment of this embodiment of the cutter bar 62 remains as described above.

Further, the cutter bar 62 can include a cutting feature (not shown) such as a razor, serrated portion, and the like provided to an edge of the cutter bar 62. The cutting feature serves to enhance the chopping ability of the pump 10.

FIGS. 5 and 6 illustrate an example of an inlet flange 22 according to the present invention. The inlet flange 22 has a mounting portion 92 that defines a first end 93 of an interior passage 95, the interior passage 95 extending through the inlet flange 22. A plurality of apertures 98 are formed periodically about a circumference of the mounting portion 92 to communicate with fasteners (not shown) for coupling the pump 10 to a plumbing network (not shown).

An inspection port 102 is provided to the inlet flange 22 at a location to permit observation of the clearance C between the cutter bar 62 and the impeller 32. The inspection port 102 can be a generally transparent material disposed within a wall of the inlet flange 22 as shown in FIGS. 2 and 6. Alternatively, the inspection port 102 can be a hinged door (not shown) that can be opened when the pump is not operating to permit inspection of the clearance C as well as routine maintenance. Regardless of the nature of the inspection port 102, it should permit observation of at least the clearance C between the cutter bar 62 and the impeller 32.

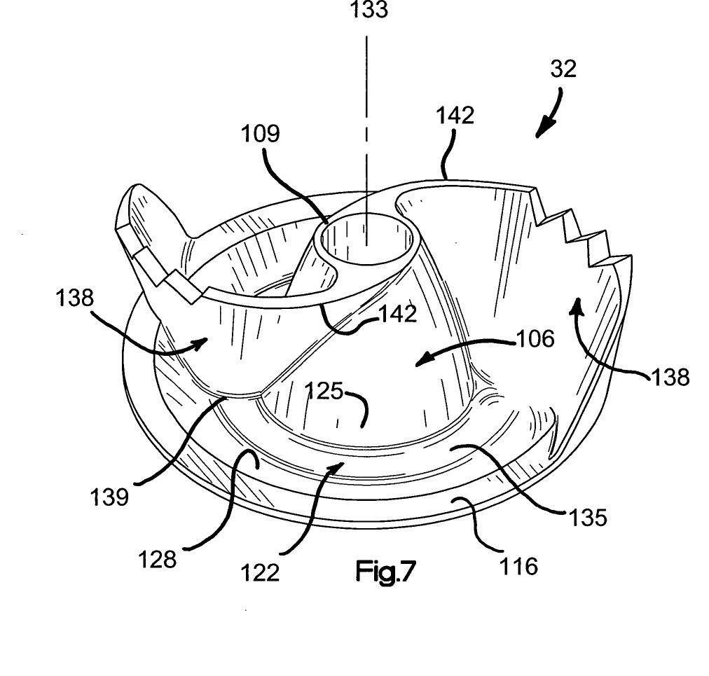

The impeller 32 according to the illustrative embodiment of the present invention is shown in FIGS. 7-9. The impeller 32 is a generally bowl-shaped object having a central hub 106 that is open on first and second ends 109, 112, respectively. An outer lip 116 is concentric with, and encircles the hub 106, while a concavity 122 is situated therebetween. The concavity 122 is formed between an inclined wall 125 of the hub 106 and an inclined wall 128 adjacent to the outer lip 116. Best shown in FIG. 9, the two inclined walls 125, 128 are inclined at angles relative to a central axis 133 of the hub 106 to form a generally “v” shaped cross-section that opens in the direction of the first end 109. The two inclined walls 125, 128 are joined at an arcuate portion 135, thereby forming a rounded trough at the base of the inclined walls 125, 128 instead of forming an acute angle as in the case of the inclined members of the letter “v”.

The impeller 32 further comprises a plurality of chopping blades 138 that project radially from the hub 106. Each chopping blade 138 has a height in a direction generally parallel to the central axis 133 measured from a base 139 to a leading edge 142. According to the illustrative embodiment, the chopping blades 138 have a height such that the leading edges 142 are level with the first end 109 of the hub 106. Chopping blades 138 of any size, however, are included within the scope of the present invention. And regardless of the size of the chopping blades 138, the chopping blades 138 are arranged in a symmetrical number and pattern about the central axis 133 to allow rotation of the impeller 32 in a generally balanced fashion.

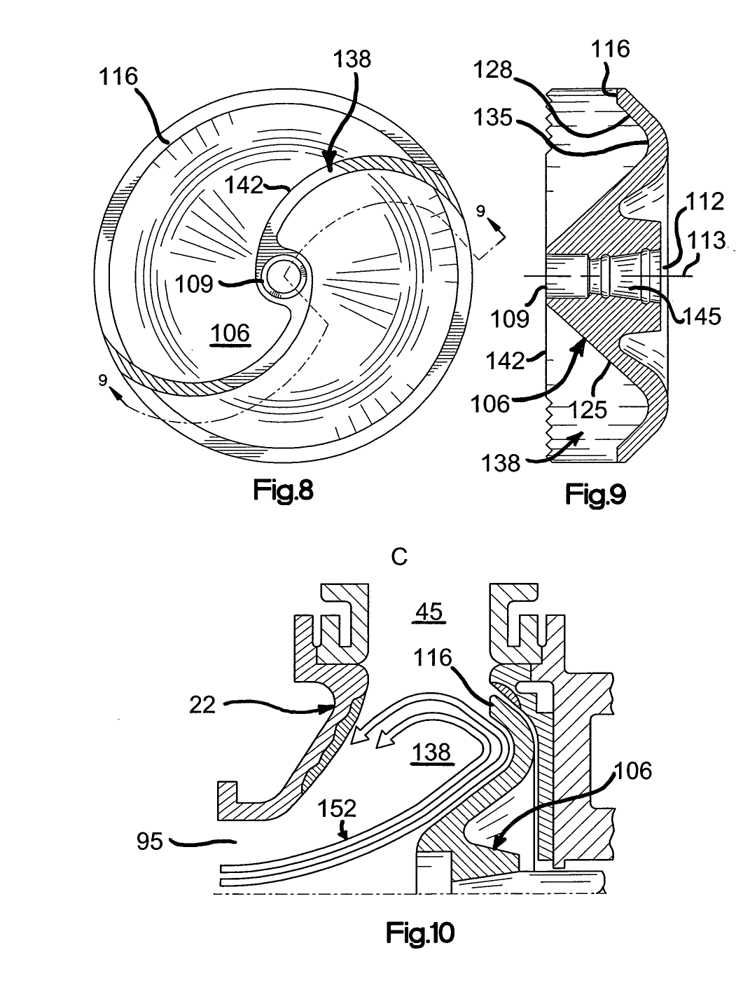

The chopping blades 138 are helical-shaped in the illustrative embodiment to enhance their capability to impart a radial force on fluid entering the pumping chamber 19, and to create a vortex within the pumping chamber 19. The leading edge 142 of each chopping blade 138 is horizontally offset ahead of the base 139 in the direction of forward rotation of the impeller 32. Thus, as the impeller 32 is rotated, the leading edge 142 is the forward-most portion of each chopping blade 138. As shown in FIGS. 7 and 8, the leading edges 142 are the forward-most portions of the chopping blades 138 when the impeller 32 is rotated in a counter-clockwise direction.

Each chopping blade 138 also includes a serrated portion 143 provided to the leading edge 142. The serrated portion 143 can be any cutting pattern found on conventional cutting devices such as knives, saws, razors and the like. For example, the serrated portion 143 illustrated in FIG. 7 comprises a plurality of teeth 144 that pass adjacent to the cutter bar 62 as the impeller 32 is rotated.

FIG. 10 illustrates an example of a flow pattern 152 created by the impeller 32 of the present invention. As the impeller 32 is rotated, the motion of the impeller 32 and the chopping blades 138 creates a vortex and imparts a centrifugal force on the fluid in the pumping chamber 19. As the fluid is forced in a generally radial direction, some of the fluid is introduced into the concavity 122. At least a portion of the fluid introduced into the concavity 122 has a force imparted on it by the inclined wall 128 adjacent to the outer lip 116, and, as a result, is directed generally toward the clearance C between the cutter bar 62 and the chopping blades 138 of the impeller 32.

The impeller 32 is mountable on the drive shaft 28 such that rotation of the drive shaft 28 by the pump driving device causes rotation of the impeller. FIG. 2 illustrates that the proximate end 56 of the drive shaft 28 extends through an interior passage 145 between the first end 109 and the second end 112 of the hub 106. A fastener 148, such as a screw, bolt and the like, engages both the impeller 32 and the proximate end 56 of the drive shaft 28 to secure the impeller 32 to the drive shaft 28. There, the directed fluid, and entrained objects, are subjected to the forces of the cutter bar 62 and the impeller 32.

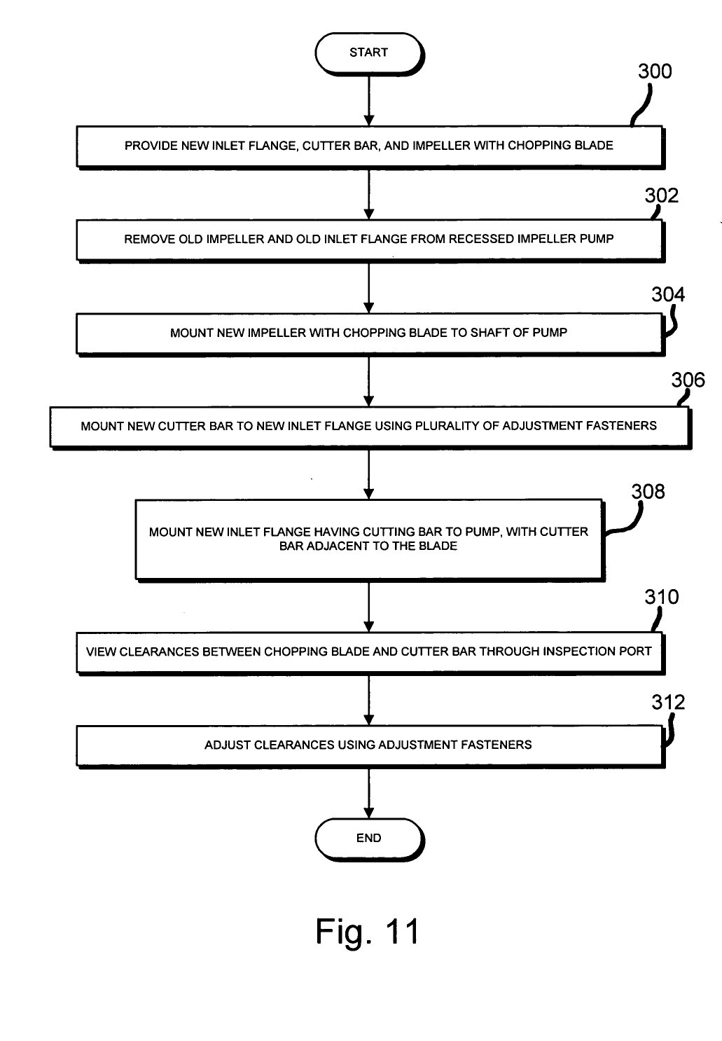

FIG. 2 provides an illustration of the assembled pump 10 in accordance with the illustrative embodiment. However, conventional recessed impeller pumps can be converted into the pump 10 in accordance with the present invention by replacing the conventional recessed impeller assembly with an impeller assembly 12 of the present invention. An illustrative embodiment of a method for converting a recessed impeller pump according to the present invention can be understood with reference to FIG. 11. Generally, the method comprises removing the conventional recessed impeller, and replacing the conventional inlet flange and impeller with an inlet flange 22 provided with a cutter bar 62 and an impeller having a chopping blade 138 and concavity 122, respectively.

At step 300 an inlet flange 22, cutter bar 62 and impeller 32 according to the present invention are provided. The cutter bar 62 and impeller 32 are substantially the same as the cutter bar 62 and impeller 32 discussed above. The inlet flange 22 can also be substantially the same structure discussed above, or, the existing inlet flange of the recessed impeller pump can be removed at step 302 and machined into the inlet flange 22 discussed above. Regardless of the manner in which the inlet flange 22 is provided, the inlet flange 22 to be provided to the converted pump 10 will be referred to herein generally as the inlet flange 22.

In addition to removing the conventional inlet flange, the recessed impeller is also removed from the recessed impeller pump at step 302. With the recessed impeller having been removed, the impeller 32 is mounted on the drive shaft 28 at step 304. To install the impeller 32, the interior passage 145 extending between first and second ends 109, 112 of the hub 106 is aligned concentrically with the drive shaft 28 and slid axially along axis 52 over the proximate end 56 of the drive shaft 28. Fastener 148 is placed in communication with the proximate end 56 of the drive shaft 28, the fastener 148 having been inserted through the first end 109 of the hub 106. Through the communication with the proximate end 56 of the drive shaft 28, fastener 148 secures the impeller 32 to the drive shaft 28.

At step 306, the cutter bar 62 is provided adjacent to the inlet flange 22, which is either a replacement inlet flange or a machined inlet flange of the recessed impeller pump. The plurality of compatibly threaded receptors 71 of the plate 65 are aligned concentrically with the apertures 75 in the inlet flange 22. Threaded fasteners 67 are extended through the apertures 75 and received in the compatibly threaded receptors 71 to adjustably couple the cutter bar 62 adjacent to the inlet flange 22.

As previously mentioned, the cutter bar 62 can also be adjustably coupled adjacent to the inlet flange 22 separate from the plate 65. According to such an embodiment, the threaded fasteners 67 are to be extended through the apertures 75 and received in apertures formed in opposite ends of the cutter bar 62. Adjustment of the position of the cutter bar 62 is otherwise the same as that discussed above.

The inlet flange 22 is to be installed to the pump housing 16 at step 308 such that the cutter bar 62 is adjustably coupled adjacent to the inlet flange 22 and separated from the chopping blades 138 of the impeller 32 by the clearance C. This clearance C is visually observable through the inspection port 102 provided to the inlet flange 22 at step 310, and adjusted as desired at step 312 by extending and/or retracting the threaded fasteners 67 as described above.

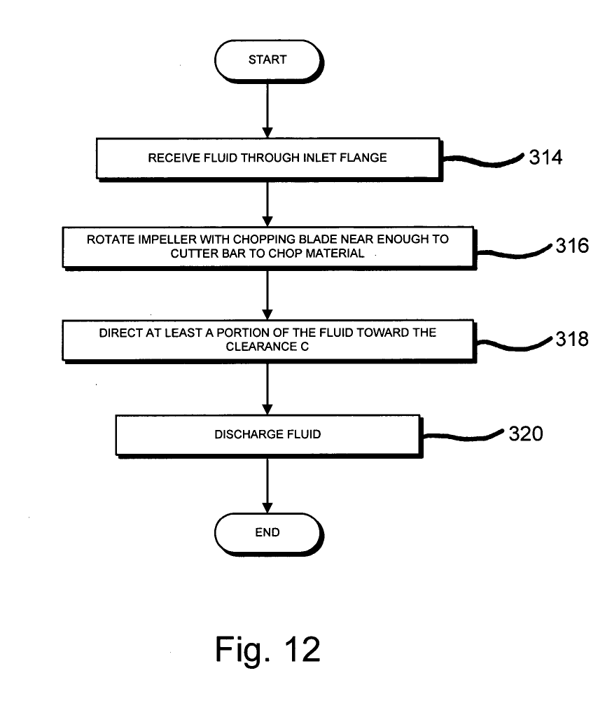

A method of operating a pump 10 according to an illustrative embodiment of the present invention is shown in FIG. 12. At step 314, the pump 10 according to the illustrative embodiment of the present invention, regardless of whether it was converted or manufactured as a new pump, has fluid introduced into the pumping chamber 19 through inlet flange 22 from an attached plumbing network. The pump driving device causes rotation of the drive shaft 28, the rotation of the drive shaft 28 causing rotation of the impeller 32 at step 316. Objects such as debris and other solid materials entrained in the fluid entering the pumping chamber 19 are subjected to a shearing force created as the chopping blades 138 of the impeller 32 are rotated adjacent to the cutter bar 62. In this manner, the leading edges 142 of the chopping blades 138 chop the objects entrained in the fluid as those objects flow adjacent to the clearance C between the impeller 32 and the cutter bar 62.

Objects not chopped by the shearing force created by the rotation of the impeller adjacent to the cutter bar 62 experience forces exerted by a vortex of fluid created in the pumping chamber 19 by the rotation of the impeller 32. At step 318, at least some of these objects are directed generally toward the clearance C between the impeller 32 and the cutter bar 62 by a fluid flow pattern created by the concavity 122 of the impeller 32. Objects so directed toward the clearance C are subjected to at least one of the shearing force between the chopping blades 138 and the cutter bar 62, and the chopping force from the serrated portion 143 of the chopping blades 138. The fluid and the chopped material are then discharged from the pumping chamber 19 through the outlet flange 25 at step 320 due to the centrifugal force imparted on the fluid by the impeller 32.

From the above description of the invention, those skilled in the art will perceive improvements, changes and modifications. Such improvements, changes and modifications within the skill of the art are intended to be covered by the appended claims.

What is claimed is:

1. An impeller assembly to be installed in a pump having a pump housing for enclosing a pumping chamber, an inlet flange through which a fluid is to be introduced into the pumping chamber at a first pressure, an outlet flange through which the fluid is to be discharged from the pumping chamber at a second pressure, and a rotatable shaft that is to be operatively coupled to a pump driving device, the impeller assembly comprising:
a cutter bar to be coupled to the pump housing adjacent to the inlet flange; and
an impeller for imparting a centrifugal force on fluid entering the pumping chamber, the impeller being mountable on the shaft at a distance from the cutter bar when the cutter bar is coupled to the pump housing to form a clearance between the impeller and the cutter bar, wherein
the impeller comprises a concavity shaped to direct at least a portion of the fluid entering the pumping chamber generally toward the clearance between the impeller and the cutter bar.

2. The impeller assembly according to claim 1, wherein the impeller comprises a chopping blade that extends from the impeller in a direction generally parallel to a central axis of the impeller.

3. The impeller assembly according to claim 2, wherein the cutter bar is adjustably coupled to the pump housing between the inlet flange and the impeller to allow adjustment of the clearance between the chopping blade and the cutter bar.

4. The impeller assembly according to claim 2, wherein the chopping blade comprises a serrated portion that passes adjacent to the cutter bar during rotation of the impeller.

5. The impeller assembly according to claim 4, wherein the serrated portion comprises a plurality of teeth.

6. The impeller assembly according to claim 2, wherein the clearance is suitably sized such that rotation of the impeller adjacent to the cutting blade imparts a shearing force on objects entrained in the fluid entering the pumping chamber.

7. The impeller assembly of claim 1, wherein the cutter bar is to be coupled to the pump housing by a plurality of fasteners that are adjustable externally of the pump housing without disassembling the pump housing.

8. The impeller assembly according to claim 7, wherein the clearance between the impeller and the cutter bar is adjustable externally of the pump housing by adjusting the plurality of fasteners.

9. The impeller assembly according to claim 1, wherein the clearance is suitably sized such that rotation of the impeller adjacent to the cutting blade imparts a shearing force on objects entrained in the fluid entering the pumping chamber.

10. The impeller assembly according to claim 1, wherein the cutter bar is adjustably coupled to the pump housing between the inlet flange and the impeller to allow adjustment of the clearance between the impeller and the cutter bar.

11. The impeller assembly according to claim 10, wherein the clearance between the impeller and the cutter bar is adjustable externally of the pump housing.

12. The impeller assembly according to claim 11, wherein the external adjustment of the clearance between the impeller and the cutter bar can be performed without disassembling the pump housing.

13. The impeller assembly according to claim 1 further comprising an inspection port provided to the pump housing, the inspection port permitting observation of the clearance between the impeller and the cutter bar.

14. The impeller assembly of claim 1, wherein the impeller comprises a surface in a plane extending radially from a central axis to oppose the inlet flange, and a chopping blade having a curved member normal to the plane, wherein
the curved member is shaped to create a vortex when rotated and comprises an edge to be rotated about the central axis adjacent to the cutting bar.

15. An impeller assembly to be installed in a pump having a pump housing for enclosing a pumping chamber, an inlet flange through which a fluid is to be introduced into the pumping chamber at a first pressure, an outlet flange through which the fluid is to be discharged from the pumping chamber at a second pressure, and a rotatable shaft that is to be operatively coupled to a pump driving device, the impeller assembly comprising:
a cutter bar to be adjustably coupled to the pump housing adjacent to the inlet flange; and
an impeller for imparting a centrifugal force on fluid entering the pumping chamber, the impeller being mountable on the shaft at a distance from the cutter bar when the cutter bar is coupled to the pump housing to form a clearance between the impeller and the cutter bar, wherein
a position of the cutter bar is adjustable relative to the impeller to provide adjustment of the clearance between the cutter bar and the impeller.

16. The impeller assembly according to claim 15, wherein the impeller comprises a chopping blade that extends from the impeller in a direction generally parallel to a central axis of rotation of the impeller.

17. The impeller assembly according to claim 16, wherein the chopping blade comprises a serrated portion to be rotated adjacent to the cutter bar during rotation of the impeller within the pumping chamber.

18. The impeller assembly according to claim 17, wherein the serrated portion comprises a plurality of teeth.

19. The impeller assembly according to claim 15, wherein the clearance is suitably sized such that rotation of the impeller adjacent to the cutting blade imparts a shearing force on objects entrained in the fluid entering the pumping chamber.

20. The impeller assembly according to claim 15, wherein the clearance between the impeller and the cutter bar is adjustable externally of the pump housing.

21. The impeller assembly according to claim 15, wherein the impeller comprises a surface in a plane extending radially from a central axis to oppose the inlet flange, and a chopping blade having a curved member normal to the plane, wherein
the curved member is shaped to create a vortex when rotated and comprises a distal edge to be rotated about the central axis adjacent to the cutting bar.

22. A pump comprising:
a pump housing for enclosing a pumping chamber, the pump housing having an inlet flange through which a fluid is to be introduced into the pumping chamber at a first pressure, and an outlet flange through which the fluid is to be discharged from the pumping chamber at a second pressure;
a rotatable shaft that is to be operatively coupled to a pump driving device;
a cutter bar; and
an impeller for imparting a centrifugal force on fluid being introduced into the pumping chamber, the impeller being mountable on the shaft at a distance from the cutter bar within the pump housing to form a clearance between the impeller and the cutter bar, wherein
the impeller comprises a concavity shaped to direct at least a portion of the fluid entering the pumping chamber generally toward the clearance between the impeller and the cutter bar as the impeller is rotated.

23. The pump according to claim 22, wherein the impeller comprises a chopper blade extending from the impeller in a direction to oppose the cutter bar within the pump housing.

24. The pump according to claim 23, wherein the chopper blade comprises a serrated portion that is to be rotated adjacent to the cutter bar as the impeller is rotated.

25. The pump according to claim 24, wherein the serrated portion comprises a plurality of teeth.

26. The pump according to claim 22, wherein the clearance is suitably sized such that rotation of the impeller adjacent to the cutter bar imparts a shearing force on objects entrained in the fluid being introduced into the pumping chamber.

27. The pump according to claim 22 further comprising a plurality of fasteners for coupling the cutter bar to the pump housing adjacent to the inlet flange.

28. The pump according to claim 27, wherein the plurality of fasteners are adjustable externally of the pump housing to adjust the clearance between the impeller and the cutter bar.

29. The pump according to claim 22 further comprising an inspection port to permit observation of at least the clearance between the impeller and the cutter blade.

30. The pump according to claim 29, wherein the inspection port is provided to the inlet flange.

31. A pump comprising:
a pump housing for enclosing a pumping chamber, the pump housing having an inlet flange through which a fluid is to be introduced into the pumping chamber at a first pressure, and an outlet flange through which the fluid is to be discharged from the pumping chamber at a second pressure;
a rotatable shaft that is to be operatively coupled to a pump driving device;
a cutter bar; and
an impeller for imparting a centrifugal force on fluid being introduced into the pumping chamber, the impeller being mountable on the shaft at a distance from the cutter bar within the pump housing to form a clearance between the impeller and the cutter bar, wherein
a position of the cutter bar is adjustable relative to the impeller within the pump housing to provide adjustment of the clearance between the cutter bar and the impeller.

32. The pump according to claim 31, wherein the impeller comprises a concavity shaped to direct at least a portion of the fluid in the pumping chamber generally toward the clearance between the impeller and the cutter bar.

33. The pump according to claim 31, wherein the impeller comprises a chopping blade that extends from the impeller in a direction generally parallel to a central axis of rotation of the impeller.

34. The pump according to claim 33, wherein the chopping blade comprises a serrated portion to be rotated adjacent to the cutter bar during rotation of the impeller within the pumping chamber.

35. The pump according to claim 34, wherein the serrated portion comprises a plurality of teeth.

36. The pump according to claim 31, wherein the clearance is to be adjusted to a suitable distance such that rotation of the impeller adjacent to the cutting blade imparts a shearing force on objects entrained in the fluid entering the pumping chamber.

37. The pump according to claim 31, wherein the clearance between the impeller and the cutter bar is adjustable externally of the pump housing.

38. The pump according to claim 31, wherein the impeller comprises a surface in a plane extending radially from a central axis to oppose the inlet flange, and a chopping blade having a curved member normal to the plane, wherein
the curved member is shaped to create a vortex when rotated and comprises a distal edge to be rotated about the central axis adjacent to the cutting bar.

39. A pump comprising:
a pump housing that defines a pumping chamber, the pump housing having an inlet flange through which a fluid is to be introduced into the pumping chamber at a first pressure, and an outlet flange through which the fluid is to be discharged from the pumping chamber at a second pressure;
a rotatable shaft that is to be operatively coupled to a pump driving device;
a cutter bar;
an impeller for imparting a centrifugal force on fluid being introduced into the pumping chamber, the impeller being mountable on the shaft at a distance from the cutter bar within the pump housing to form a clearance between the impeller and the cutter bar; and
an inspection port for observing the clearance between the impeller and the cutter bar.

40. The pump according to claim 39, wherein the impeller comprises a chopping blade that extends from the impeller in a direction generally parallel to a central axis of rotation of the impeller.

41. The pump according to claim 40, wherein the chopping blade comprises a serrated portion to be rotated adjacent to the cutter bar during rotation of the impeller within the pumping chamber.

42. The pump according to claim 41, wherein the serrated portion comprises a plurality of teeth.

43. The pump according to claim 39, wherein the clearance is to be adjusted to a suitable distance such that rotation of the impeller adjacent to the cutting blade imparts a shearing force on objects entrained in the fluid entering the pumping chamber.

44. The pump according to claim 39, wherein the clearance between the impeller and the cutter bar is adjustable externally of the pump housing.

45. The pump according to claim 39, wherein the impeller comprises a surface in a plane extending radially from a central axis to oppose the inlet flange, and a chopping blade having a curved member normal to the plane, wherein
the curved member is shaped to create a vortex when rotated and comprises a distal edge to be rotated about the central axis adjacent to the cutting bar.

46. A method for converting a recessed impeller pump into a chopping pump, the recessed impeller pump having an existing impeller recessed within a pumping chamber, the method comprising:
removing an existing impeller and an existing inlet flange from the recessed impeller pump;
mounting a cutter bar to an inlet flange; and
mounting an impeller on a rotatable shaft of the recessed impeller pump, the impeller having a concavity shaped to direct at least a portion of fluid in the pumping chamber generally toward the cutter bar.

47. The method according to claim 46, wherein the step of mounting the cutter bar to the inlet flange comprises:
adjustably coupling the cutter bar to the inlet flange such that a clearance between the impeller and the cutter bar is adjustable.

48. The method according to claim 47 further comprising the steps of:
viewing the clearance between the impeller and the cutter blade through an inspection port; and
adjusting the clearance to a suitable size.

49. The method according to claim 46 further comprising the steps of:
mounting the inlet flange such that a clearance established between the cutter bar and the impeller within the pumping chamber.

50. A method for operating a pump, the pump comprising a pump housing enclosing a pumping chamber, an inlet flange through which a fluid can enter the pumping chamber, an outlet flange through which the fluid is discharged from the pumping chamber, and a cutter bar coupled adjacent to the inlet flange, the method comprising:
receiving a fluid through the inlet flange;
rotating an impeller adjacent to the cutter bar to chop objects entrained in the fluid; and
directing at least a portion of the fluid entering the pumping chamber generally toward a clearance between the impeller and the cutter bar.

51. The method according to claim 50 further comprising the steps of:
observing the clearance between the impeller and the cutter bar through an inspection port; and
adjusting a position of the cutter bar to create a suitably sized clearance.
